(19) United States
(12) Patent Application Publication
(10) Pub. No.: US 2025/0337989 A1
(43) Pub. Date: Oct. 30, 2025

(54) METHOD AND DEVICE FOR MARKING VIDEO

(71) Applicant: Lemon Inc., Grand Cayman (KY)

(72) Inventor: Parth Vijay SINHA, New Delhi (IN)

(21) Appl. No.: 18/999,737

(22) Filed: Dec. 23, 2024

(30) Foreign Application Priority Data
Apr. 30, 2024 (IN) 202421034236

(51) Int. Cl. H04N 21/472; H04N 21/4788

(52) U.S. Cl. CPC H04N 21/472; H04N 21/4788

(57) ABSTRACT

Embodiments of the present disclosure relate to a method, a device, and a computer readable medium for marking a video. In the solution, a user may view a first video with a tag indicating that the first video is marked by a first user, where the first video is generated by a second user based on a first media content being created by the first user. The page for representing the first video may be switched to a profile page of the first user based on an operation associated with the tag, where the profile page of the first user may display one or more videos marked by the first user. As such, a tag may be displayed associated with the first video, so that an acknowledgement of the first user to the first video may be viewed, and thus the contribution of the second user is celebrated.

### CROSS-REFERENCE TO RELATED APPLICATION(S)

This application claims priority to Indian patent application Ser. No. 20/242,1034236, filed on Apr. 30, 2024, the disclosure of which is incorporated herein by reference in its entirety.

### FIELD

The present disclosure relates to an information technical field, and more specifically to a method, a device, and a computer readable medium for marking a video.

### BACKGROUND

With a development of the terminal technology and network technology, a variety of types of video applications are widely used. Social media platforms are continually evolving, offering new ways for content creators to interact with others.

On the social media platform, a user, such as an artist, can upload and/or post one or multiple media contents for being viewed by other users. Another user, such as a fan, can generate his/her own media content on the basis of the media content(s) of the artist. Although features like video liking, commenting, and sharing are ubiquitous across platforms, these interactions do not provide specific mechanisms for showcasing fan contributions. Therefore, there is a need to provide a mechanism to improve the interactivity on the social media platform.

### SUMMARY

The present disclosure relates to a method, a device, and a computer readable medium for viewing a marked video.

In a first aspect, there is provided a method. The method comprises: presenting a first video with a tag indicating that the first video is marked by a first user, wherein the first video is generated by a second user based on a first media content being created by the first user; and displaying, based on an operation associated with the tag from a user, a profile page of the first user including one or more videos marked by the first user, wherein the one or more videos comprise the first video.

In a second aspect, there is provided an electronic device. The device comprises: at least one display; at least one memory; and at least one processor coupled with the at least one memory and configured to cause the device to: present, by the at least one display, a first video with a tag indicating that the first video is marked by a first user, wherein the first video is generated by a second user based on a first media content being created by the first user; and display, based on an operation associated with the tag from a user, a profile page of the first user including one or more videos marked by the first user, wherein the one or more videos comprise the first video.

In a third aspect, there is provided a non-transitory computer readable storage medium. The non-transitory computer readable storage medium has computer executable instructions stored thereon, the instructions, when executed by a device, cause the device to: present a first video with a tag indicating that the first video is marked by a first user, wherein the first video is generated by a second user based on a first media content being created by the first user; and display, based on an operation associated with the tag from a user, a profile page of the first user including one or more videos marked by the first user, wherein the one or more videos comprise the first video.

In a fourth aspect, there is provided a computer program or a computer program product comprising instructions, which, when executed by a device, cause the device at least to: present a first video with a tag indicating that the first video is marked by a first user, wherein the first video is generated by a second user based on a first media content being created by the first user; and display, based on an operation associated with the tag from a user, a profile page of the first user including one or more videos marked by the first user, wherein the one or more videos comprise the first video.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example environment in which some embodiments of the present disclosure can be implemented;

FIG. 2 illustrates a signalling chart illustrating an example process in accordance with some example embodiments of the present disclosure;

FIG. 3 illustrates an example schematic for adding a spotlighted video by the first user in accordance with some example embodiments of the present disclosure;

FIG. 4 illustrates an example schematic of a profile page of the first user in accordance with some example embodiments of the present disclosure;

FIG. 5 illustrates a schematic diagram for commenting a video by the first user in accordance with some example embodiments of the present disclosure;

FIG. 6 illustrates an example schematic for sharing a video by the first user in accordance with some example embodiments of the present disclosure;

FIG. 7 illustrates an example schematic of the notification to the second user in accordance with some example embodiments of the present disclosure;

FIG. 8 illustrates a flowchart of an example method in accordance with some example embodiments of the present disclosure;

FIG. 9 illustrates an example schematic of visibility of a spotlighted video in accordance with some example embodiments of the present disclosure; and

FIG. 10 illustrates a schematic block diagram of an example device that may be used to implement embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

A social media platform may be implemented by a social media application, which may be an application software that can provide users with variety functions such as creating, editing, viewing, interacting related to media contents.

In the present disclosure, a term “media content” is used for representing a content that is posted on the social media platform, the media content may be a streamed content. In some examples, the media content may be in a form of video, audio, text, or the like. For example, the media content may be a video with a few or more seconds. For example, the media content may be a music, such as a segment of a song. It should be noted that the examples of the media content herein are only for illustrative without any limitations, some other forms or formats should be also included in the scope of the present disclosure.

As mentioned, a user, such as an artist, can upload and/or post one or multiple media contents for being viewed by other users. In some instances, an artist can upload his/her own music, for example, the artist may be a content creator of the music, such as a singer, a lyricist, a composer, etc. For ease of description, a first user is used in the following embodiments to represent the artist. For instance, the first user may use his/her device to access and browse the social media platform. As mentioned, another user, such as a fan or an audience, can generate his/her own media content on the basis of the media content(s) of the artist. In some instances, a fan can create a video based on a music of the artist, for example, a segment of the music may be used as a background music of the video. For ease of description, a second user is used in the following embodiments to represent the fan. For instance, the second user may use his/her device to access and browse the social media platform.

The first user may browse the social media platform, and may notice that the second user has created a video based on his/her music, in this event, some interactions like video liking, commenting, and sharing may be performed. However, these manners are less interactive. A more interactive way may be needed to enhance and showcase the fan contributions.

Embodiments of the present disclosure provide a solution for social media platform. In the solution, a user may view a first video with a tag indicating that the first video is marked by a first user, where the first video is generated by a second user based on a first media content being created by the first user. The page for representing the first video may be switched to a profile page of the first user based on an operation associated with the tag from the user, where the profile page of the first user may display one or more videos marked by the first user. As such, a tag may be displayed associated with the first video, so that an acknowledgement of the first user to the first video may be viewed, and thus the contribution of the second user is celebrated. In the solution, the tag may be trigged to switch to the profile page of the first user, thus the operation for viewing the profile page may be simplified and the user experience can be enhanced. Principles and implementations of the present disclosure will be described in detail below with reference to the figures.

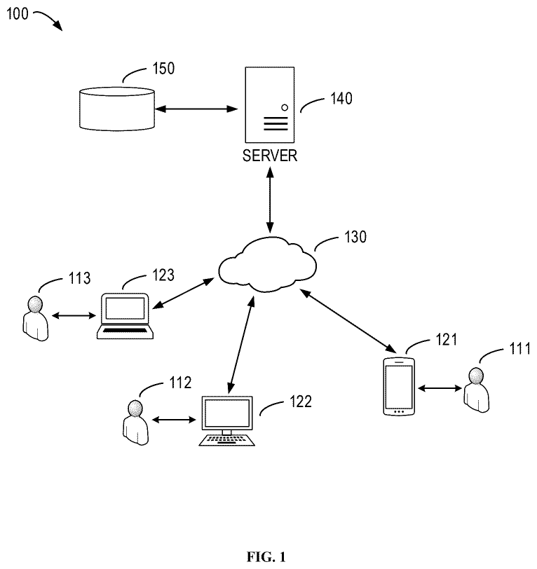

FIG. 1 illustrates an example environment 100 in which some embodiments of the present disclosure can be implemented. As illustrated in FIG. 1, the environment 100 may include devices 121-123 and associated users 111-113, a network 130, a server 140, and a storage 150.

Each of devices 121-123 may connect to the network 130, and the network 130 is communicatively connected to the server 140, thereby forming a communication connection between the devices and the server. The users 111-113 can surf the internet by using the respective devices 121-123. For example, each of the devices 121-123 has a user interface, via which the user can provide an input command. The user interface may include a graphic user interface (GUI) which can be touched or clicked by a user, a keyboard, a mouse or the like. For example, each of the devices 121-123 may has a display for presenting images, texts, or the like.

In the present disclosure, a device such as each of devices 121-123, may refer to a terminal device having wireless or wired communication capabilities. Example of the terminal devices may include, but not limited to, user equipment (UE), personal computers, desktops, mobile phones, cellular phones, smart phones, personal digital assistants (PDAs), portable computers, tablets, wearable devices, internet of things (IoT) devices, devices on vehicle for V2X communication, or the like. It should be noted that although the device 121 is illustrated as a mobile phone, the device 122 is illustrated as a desktop, and the device 123 is illustrated as a portable computer, the types of the devices 121-123 are not limited for this aspect.

The server 140 may have a functionality for supporting a social media platform. The server 140 may be implemented as centralized or distributed. For instance, components of the server 140 may be distributed in multiple different machines and/or in the cloud.

The storage 150 may have a storage medium storing information for supporting the social media platform. For instance, the media contents may be stored in the storage 150.

It is to be understood that the type and number of devices in FIG. 1 is given for the purpose of illustration without suggesting any limitations to the present disclosure. For example, the user 113 may represent a large amount of users who can access the social media platform.

For ease of following embodiments, it is assumed that the user 111 is a first user who may be an artist uploading or posting his/her music, the user 112 is a second user who may be a fan creating a video based on the music of the first user 111, and the user 113 is a third user who is different from the first user 111 and the second user 112. It should be appreciated with music and video are used for representing a media content uploaded by the artist and a media content created by the fan, but the embodiments of the present disclosure do not limit for this aspect. In other words, the embodiments with “music” and “video” are only for illustration without any limitations, in actual usage, the “music” and “video” may be replaced by another type of content.

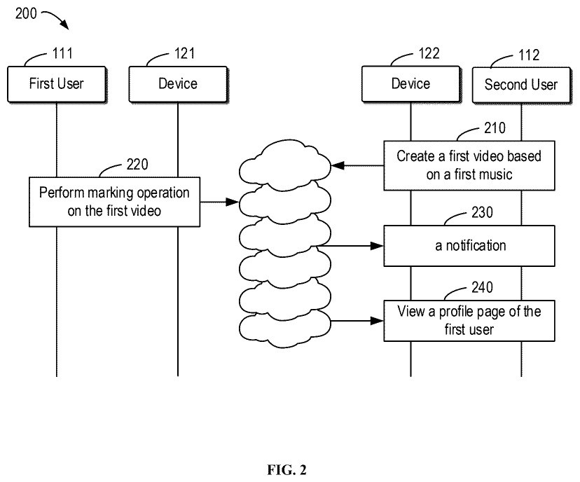

Reference is now made to FIG. 2, which illustrates a signalling chart illustrating an example process 200 in accordance with some example embodiments of the present disclosure. The process 200 may involve the first user 111 who using the device 121, and the second user 112 who using the device 122, for example both the first user 111 and the second user 112 can access the social media platform.

The second user 112 may create a first video based on a first music through the device 122 at 210. In some implementations, the second user 112 may create the first video and post (or issue) it to the social media platform, in this way, some other users may view the first video. For example, the first video may be referred to as a fan-made content.

In some implementations, the first music may be associated with the first user 111, for example, the first user 111 may be a singer of the first music. In some example embodiments, the second user 112 may be aware of the first music. For example, the second user 112 may obtain the source of the first music from a music application. For another example, the first user 111 may upload or post the first music through the device 121, and the second user 112 can access the first music.

In some implementations, the second user 112 may generate the first video based on part or all of the first music. In some examples, a segment of the first music may be a background audio of the first video. In some other examples, a segment of the first music may be a part of the background audio of the first video.

For the first video, the first user 111 perform a marking operation at 220. In the present disclosure, the marking operation may be interchangeably used with one of: a spotlighting operation, a pinning operation, a labeling operation, a highlighting operation, or the like, the present disclosure does not limit for this aspect. For example, some of the following embodiments are described with reference to the term “spotlight”.

The marking operation may be performed by the first user 111 on the first video, so that the first video will be displayed on a profile page of the first user 111.

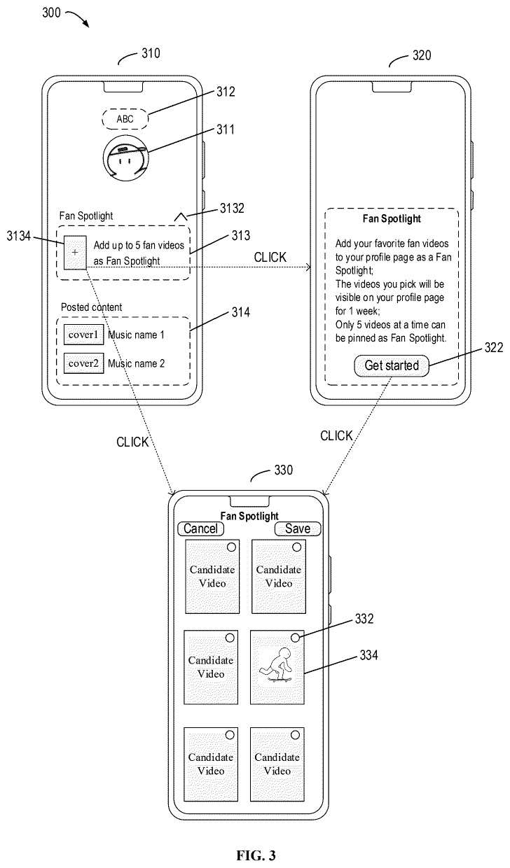

In the present disclosure, various manners are supported for enabling the marking operation, examples of which will be provided with reference to FIGS. 3-6.

FIG. 3 illustrates an example schematic 300 for adding a spotlighted video by the first user 111. A profile page 310 of the first user 111 is illustrated. The profile page 310 may curate an avatar 311 of the first user 111, a username 312 of the first user 111, a spotlighted area 313, and a posted content area 314. It is understood that the profile page 310 may further display more information, e.g. other profile information of the first user 111, one or more controls for switching to another page or for editing the profile information.

In the present disclosure, an area on the profile page 310 may also be called as a section, a partition, a zone, a region, or the like. The posted content area 314 may be optionally, which is used for displaying one or more contents (such as music) that are uploaded or posted by the first user 111.

The spotlighted area 313 may also be a fan spotlight area, which may be configured to display one or more videos that are spotlighted by the first user 111. For enhancing the spotlighting feature, a maximum number of the spotlighted video may be defined, for example, the maximum number (i.e. a predefined threshold) may be represented as an integer N, which may be 3 or 5 or another value. For instance, up to N videos can be shown in the spotlighted area 313.

In some instances, an unfolding mark 3132 may also be shown associated with the spotlighted area 313. For example, the spotlighted area 313 may be unfolded based on an operation, such as clicking, on the unfolding mark 3132.

As illustrated, there is no spotlighted video shown in the spotlighted area 313 in FIG. 3A, however, it is understood that in some other cases, there may be one or multiple spotlighted videos shown in the spotlighted area 313, and a total number of the shown spotlighted videos is less than N.

Prompt information may be displayed associated with the spotlighted area 313. As shown in FIG. 3A, an adding mark “+” 3134 is shown for the first user 111 to add a spotlighted video. Optionally, text information “add up to 5 fan videos” is also shown, for the first user 111 knowing that the maximum number N=5.

Upon an operation for adding a spotlighted video from the first user 111, a page 330 curating a plurality of candidate videos may be displayed, for the first user 111 to select a video as a spotlighted video. In some examples, the first user 111 may click the adding mark “+” 3134, and the page 330 is shown in response to the clicking operation on the adding mark “+” 3134.

In some embodiments, guideline information 320 may be displayed, upon the operation for adding a spotlighted video from the first user 111; and in addition, the page 330 curating a plurality of candidate videos may be displayed in response to another adding operation associated with the guideline information 320. In some examples, the guideline information may be displayed for the first time, e.g., there is no spotlighted video in the spotlighted area 313, e.g., it is the first time for the first user 111 using the spotlighting function. In some instances, the guideline information 320 may be shown as a mask above the profile page 310.

In some instances, the guideline information may indicate one or more of the following: a functionality of the spotlighting, a displaying time period for a spotlighted video, or the maximum number. For instance, the guideline information may include: add your favorite fan videos to your profile page as a Fan Spotlight; the videos you pick will be visible on your profile page for 1 week; only 5 videos at a time can be pinned as Fan Spotlight. It should be noted that the guideline information described is only for illustrative without any limitation.

In some instances, a control associated with the guideline information may be further displayed, for instance, the control may be triggered by the first user 111 to switch to the page 330. For example, the control may be a button of “get started” 322. In some examples, the first user 111 may click the button “get started” 322, and the page 330 is shown in response to the clicking operation on the button “get started” 322. In some other examples, the first user 111 may not click the “get started” 322, and the page 330 is shown after a time duration elapses, for example, after the guideline information has been presented for a time duration such as 5 s, the page 330 can be displayed.

In some embodiments, the page 330 may curate a plurality of candidate videos which are not created by the first user 111. Each of the plurality of candidate videos is created based on an audio (such as a music) of the first user 111. As a non-limited example, the plurality of candidate videos may include a first candidate video which is generated based on a first music of the first user 111, a second candidate video which is generated based on a second music of the first user 111, a third candidate video which is generated based on a first music, etc. In some examples, different candidate videos may be created by a same user or by different users. In some examples, different candidate videos may be created based on a same music or different music of the first user 111.

In some instances, the social media platform may determine the plurality of candidate videos by using a matching algorithm or a detecting algorithm. For instance, if a similarity of a background audio of a video and a first music exceeds a threshold (such as 0.9 or another value), the video may be determined as one candidate video. For instance, if a video has been labeled with a second music, the video may be determined as one candidate video, for example, comments on the video may indicate that the video uses the second music.

In addition or alternatively, the first user 111 may select one or multiple (e.g. up to N) candidate videos on the page 330. In some instances, a selection control may be shown associated with each candidate video. For instance, the first user 111 may select (or click) the selection control 332 to pick the candidate video 334.

In some embodiments, one or more other controls may be further displayed, by triggering which the page 330 may be switched to a different page. For instance, a “cancel” control may be triggered, so as to switch back to the page 310. For instance, a “save” control may be triggered, e.g. after picking the candidate video 334, so as to switch to the profile page which curating the selected video as one spotlighted video. It is noted that the “save” control may be implemented as another one, such as “OK”, “confirm”, or the like.

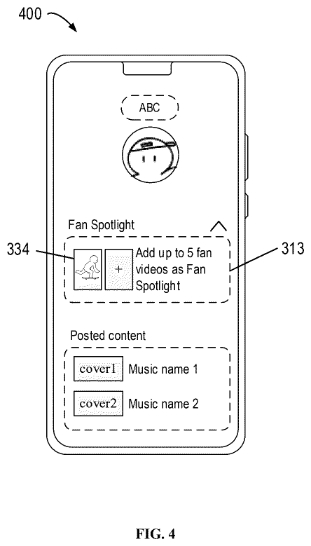

FIG. 4 illustrates an example schematic of a profile page 400 of the first user 111. As an example, the page 400 may be displayed when the first user 111 click the “save” control on page 330 after picking the candidate video 334. As shown in FIG. 4, the spotlighted area 313 includes the video 334 which is spotlighted.

In some examples, a creator of the spotlighted video may be also shown, for example, the video 334 may be created by the second user 112, and an identifier (such as an avatar) of the second user 112 may be displayed at a position associated with the spotlighted video in the spotlighted area 313. For instance, an avatar of the second user 112 may be displayed at a left bottom, but the present disclosure does not limit for this aspect.

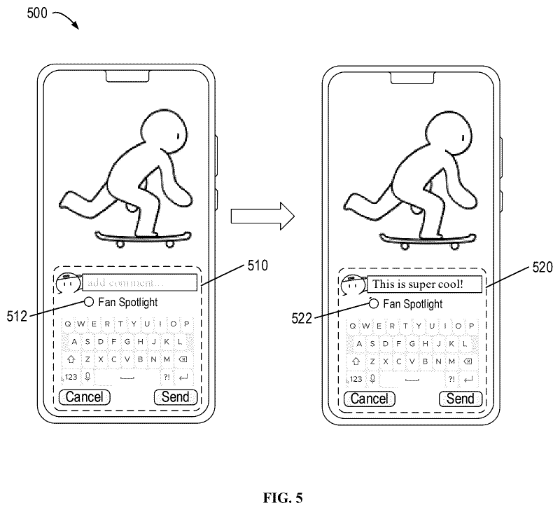

FIG. 5 illustrates an example schematic 500 for commenting a video by the first user 111. The first user 111 may be viewing the first video, and a commenting area 510 may be displayed if the first user 111 would like to comment on the first video. In some implementations, the commenting area 510 may be a comment input panel, and content of comments may be inputted by the first user 111 in the commenting box.

In some embodiments, prompt information may be displayed in the commenting area 510 and the prompt information may indicate that the first video can be spotlighted. As shown in FIG. 5, the prompt information is shown as a checkbox 512.

In some embodiments, as shown in the area 520, the first user 111 may input some comments, and may also click the checkbox as shown at 522.

In some instances, there may be more information shown in the commenting area 510. For instance, emoji may be presented, and emoji may be shown in a row which supports swiping left to find more.

In some instances, there may be one or multiple other controls shown in the commenting area 510. For instance, a checkbox of “repost” may be shown, e.g., in a same row with the checkbox 512 of fan spotlight.

In some instances, the checkbox 512 of fan spotlight may be shown when the first user 111 commenting the first video. For instance, it is shown or it is enabled when only first-level comments are initiated. In some other instances, if the first user 111 is replying to another comment made by another user, the checkbox 512 of fan spotlight may be not shown or may be disabled (e.g. cannot be checked).

In some instances, guideline information may be displayed, e.g., upon the selection operation for spotlighting the first video from the first user 111. For instance, in response to receiving a checking operation (shown at 522) by the first user 111, guideline information may be displayed. As an illustrated example, the shown guideline information may be similar with the page 320 that discussed above with reference to FIG. 3. In some examples, if no operation from the first user 111 is detected, the page 320 may be disappeared after a time duration such as 5 s, for example, the commenting box with a checked checkbox may be presented.

In some embodiments, the first video will be a spotlighted video after a confirmation operation from the first user 111. In some instances, the first user 111 may click the “send” button after checking the fan spotlight and inputting the comments, as shown in 520. In some instances, the content of the comments, such as “This is super cool!”, may also be pinned.

It is to be understood that the embodiments with reference to FIG. 5 are only for illustrative. In some examples, if the first video has been spotlighted by the first user 111, then the prompt information for spotlighting may be not shown or be disabled when the first user 111 comments the first video again; for example, the checkbox 512 and the text “Fan Spotlight” may not be shown.

In some examples, the features of “repost” and “Fan Spotlight” may be toggled, that is, at most one of the features of “repost” and “Fan Spotlight” can be selected for the first video. For example, if the first video is added to Fan Spotlight, there is no repost available for the first video. For example, if the first video is assed to Repost, there is no fan spotlight available for the first video.

In some embodiments, after commenting the first video with a spotlighting operation (e.g. checkbox selected as 522), the first user 111 may further browse back his/her profile page, as shown in FIG. 4, where the profile page 400 has a spotlighted area 313 including a spotlighted video 334.

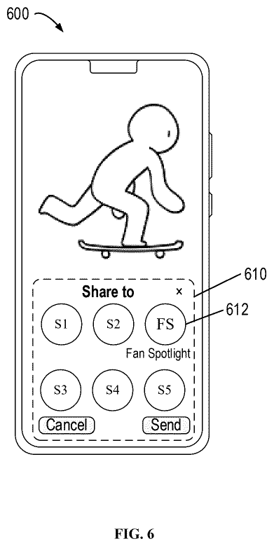

FIG. 6 illustrates an example schematic 600 for sharing a video by the first user 111. The first user 111 may be viewing the first video, and a sharing area 610 may be displayed if the first user 111 would like to share on the first video. In some implementations, the sharing area 610 may be a share panel or share page, and some options may be displayed for the first user 111 to select. In some instances, the first user 111 may click a share panel entrance, so as to present the sharing area 610. In some implementations, one of the options on the sharing area 610 may be a spotlighting control 612.

In some embodiments, the first user 111 may click the spotlighting control 612, so as the spotlight the first video.

In some embodiments, the first user 111 may click the spotlighting control 612 and further click a confirm button (such as the “send” in FIG. 6), so as the spotlight the first video.

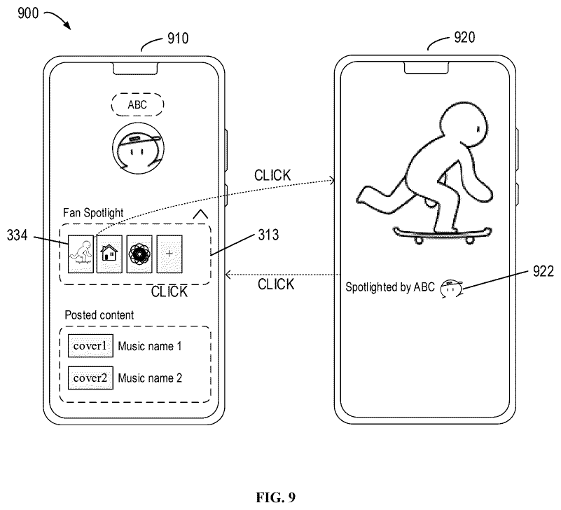

In some embodiments, the first user 111 may click the spotlighting control 612, and then guideline information may be displayed accordingly. In some instances, a control associated with the guideline information may be further displayed, for instance, the control may be triggered by the first user 111 so as the spotlight the first video. For example, the control may be a button of “Add as Fan Spotlight”. In some examples, the first user 111 may click the button “Add as Fan Spotlight”, and a page presenting the first video with a tag (e.g., also be called as a label) may be displayed. For example, the page may be that shown at 920 in FIG. 9 below, and the tag 922 may indicate that the first video is spotlighted by the first user 111 (with a username “ABC”).

According to some embodiments with reference to FIGS. 3-6, the first video can be marked (e.g. spotlighted) by the first user 111 e.g. through the device 121. In this way, artists can handpick and showcase their favorite fan-made videos directly on their profile pages based on spotlighting operations, thus the fans' creativity and contributions can be celebrated.

Specifically, a dedicated feature is provided to allow the first user 111 (i.e. the artist) to prominently acknowledge and celebrate the creative contribution of the second user 112 (i.e. the fan).

Referring back to FIG. 2, a notification is provided to the device 122 at 230, and the second user 112 may read the notification. In some implementations, the notification may indicate that the first video is marked by the first user 111.

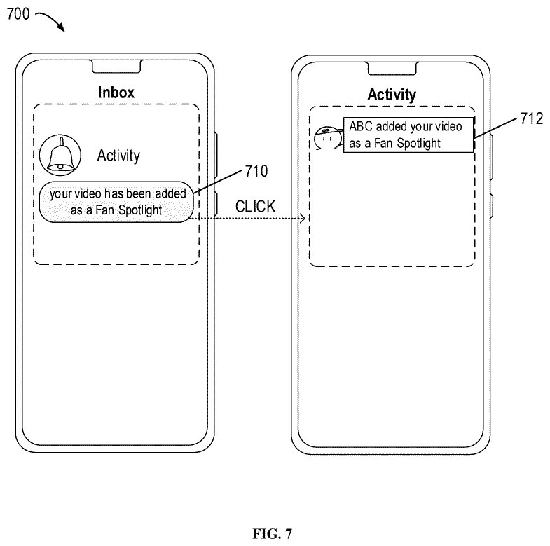

FIG. 7 illustrates an example schematic 700 of the notification to the second user 112. In some instances, the notification may be a message 710 associated with activity in the messaging inbox. For instance, the message 710 may indicate a name of the first user 111 and a congratulatory note.

In some instance, the second user 112 may determine to check details of the notification. For instance, the second user 112 may click the message 710 and the details 712 may be displayed. In some examples, the details 712 may include some or all of the following: an avatar of the first user 111, a name of the first user 111, a time when the first video is spotlighted, and information indicating that the first video is spotlighted by the first user 111. As such, the second user 112 may be aware of the status of the first video in time, that is, the first video is spotlighted by the first user 111.

It is to be noted that there may be more messages in the box and there may be more activities for notifying the second user 112, which are not illustrated in FIG. 7.

Referring back to FIG. 2, the second user 112 may further view the profile page of the first user 111 at 240. In some implementations, an example of the profile page of the first user 111 may be the page 400 that shown in FIG. 4. In some examples, the second user 112 may click the avatar of the first user 111 at 712, and then the profile page of the first user 111 can be presented accordingly. It should be understood that the profile page may be displayed based on other operations and the present disclosure will not list herein.

Accordingly, the solution is provided to allow the first user (i.e. the artist) to mark the first video created by the second user (i.e. the fan), in this way, the first user 111 (i.e. the artist) can prominently acknowledge and celebrate the creative contribution of the second user 112 (i.e. the fan). Thus, the second user 112 (i.e. the fan) can be engaged with the first user 111 (i.e. the artist). By showcasing the spotlighted videos, the artist can foster a deeper connection with the fans, encouraging more fan participation and content creation. Specifically, a personalized and impactful way is provided for the first user 111 (i.e. the artist) to engage with the fan(s), which may lead to enhance fan loyalty and engagement.

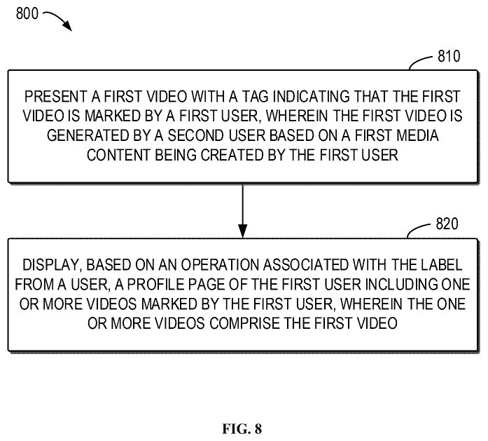

Reference is further made to FIG. 8, which illustrates a flowchart of an example method 800 in accordance with some example embodiments of the present disclosure. In some implementations, the method 800 may be implemented by a device used by a user, which can access the social media platform. With reference to FIG. 1, the device may be any of the devices 121-123.

At 810, the device presents a first video with a tag indicating that the first video is marked by a first user, where the first video is generated by a second user based on a first media content being created by the first user. At 820, the device displays, based on an operation associated with the tag from a user, a profile page of the first user including one or more videos marked by the first user, where the one or more videos comprise the first video.

In some implementations, the user may be the third user 113 as shown in FIG. 1. In some examples, the third user 113 may browse and view the first video which is created by the second user 112 and marked (e.g. spotlighted) by the first user 111. The tag of the first video may indicate that the first video is marked (e.g. spotlighted) by the first user 111. In other words, the tag may represent an endorsement from the first user 111, which is clear to all viewers. The tag may help drawing more attention to the first video created by the second user 112, potentially leading to a wider audience reach and greater recognition for the second user 112. In this event, the third user 113 may know that the first user 111 has a strong desire to interact with his/her fans. In some instances, the third user 113 may further create a fan-made video based on a media content (such as a second music) of the first user 111, therefore, a creation from a fan may be encouraged. On the other hand, the visibility of the first video is increased, and the contribution of the second user 112 is celebrated.

In some implementations, the user may be the second user 112 as shown in FIG. 1. In some examples, the second user 112 may be notified that the first video is marked (e.g. spotlighted) by the first user 111, e.g. by the notification discussed above. In some other examples, the first video, which is marked by the first user 111, may be boosted to appear on a dedicated page of the second user 112. For example, the marked first video can be boosted to appear on a “For You Page (FYP)” feed to the second user 112, ensuing increased exposure and engagement for the spotlighted fan-made video. The additional visibility benefits both the artist and the fan through increased interactions and visibility.

FIG. 9 illustrates an example schematic 900 of visibility of a spotlighted video in accordance with some example embodiments of the present disclosure. As shown in FIG. 9, a profile page 910 of the first user 111 and a displaying page 920 for showcasing the spotlighted first video are illustrated.

In some instances, for the second user 112, he/she may view the profile page 910 based on a selection operation on an identifier of the first user which is displayed on a messaging page including the notification. For instance, the second user 112 may click the avatar of the first user at 712, and then the profile page 910 may be displayed. The second user 112 may find that the first video 334 is included in the spotlighted area 313 of the profile page 910. Optionally, the second user 112 may further view the displaying page 920, e.g. by clicking the first video 334 on the profile page 910. As illustrated, the displaying page 920 may play the first video with a tag 922 (e.g. the first video is labeled with the tag 922), and the tag 922 indicates that the first video is marked by the first user 111.

In some other instances, for the second user 112, he/she may be fed with “For You Page (FYP)”, and the second user 112 may view the marked first video, e.g., by the displaying page 920. As illustrated, the displaying page 920 may play the first video which is labeled with the tag 922, and the tag 922 indicates that the first video is marked by the first user 111. Optionally, the second user 112 may further view the profile page 910 of the first user 111, e.g., by clicking the tag 922.

In some instances, the second user 112 may set the first video as private. For instance, the second user 112 would like to edit the first video. For instance, the second user 112 may find there may be some private information in the first video. In some instances, the tag 922 of the first video is removed, and the first video 334 is removed from the spotlighted area 313, based on the setting operation that sets the first video as private.

In some implementations, the user may be the first user 111 as shown in FIG. 1. It is to be appreciated that the spotlighted videos in the spotlighted area 313 can be updated. In some implementations, a maximum number of the spotlighted videos is limited, for example, a predefined threshold is used, as an example, the predefined threshold may be 5. In some example implementations, for the spotlighted first video 343, it may be removed from the spotlighted area 313 based on a removing operation from the first user 111.

In some embodiments, the first user 111 may remove the first video 343 manually. In some instances, a removing operation may be performed by the first user 111.

In some examples, the removing operation may be performed on the profile page. For example, a long press may be performed on (e.g., on the profile page 910) the first video 334 in the spotlighted area 313. In some instances, the first video 334 is removed from the spotlighted area 313, and the tag 922 of the first video is removed, based on the removing operation on the first video 334.

In some examples, the removing operation may be performed on another page, such as a sharing area. For example, for a spotlighted first video, when the first user 111 decides to share it, a de-spotlighting control may be illustrated in the sharing area. With reference to FIG. 6, if the first video has been spotlighted by the first user 111, the spotlighting control 612 will be replaced by a de-spotlighting control. For example, a selection may be performed on the de-spotlighting control in a sharing area. In some instances, the first video 334 is removed from the spotlighted area 313, and the tag 922 of the first video is removed, based on selection operation on the de-spotlighting control in a sharing area.

In some embodiments, the first video 334 can be removed from the spotlighted area 313 automatically. In some examples, a time duration for presenting a marked video in spotlighted area 313 may be defined. For example, the time duration may be 24 hours, 1 week (may refer to the guideline information 320 in FIG. 3), 10 days, or the like. In some instances, the tag 922 of the first video is removed, and the first video 334 is removed from the spotlighted area 313, if the time duration elapses. For instance, the time point when the first video is marked is t1, the time duration is L, then at a time point t1+L, the tag 922 of the first video will be removed and the first video 334 will be removed from the spotlighted area 313.

According to embodiments in the present disclosure, a first video, which is generated by a second user based on a first media content being created by the first user, can be marked by the first user, and a tag which indicates that the first video is marked by a first user can be generated for the first video. In the solution of the present disclosure, a page for representing the first video may be switched to a profile page of the first user based on an operation associated with the tag of the first video, where the profile page of the first user may display one or more videos marked by the first user. The tag may be displayed associated with the first video, so that an acknowledgement of the first user to the first video may be viewed, and thus the contribution of the second user is celebrated. The tag may be trigged to switch to the profile page of the first user, thus the operation for viewing the profile page may be simplified and the user experience can be enhanced.

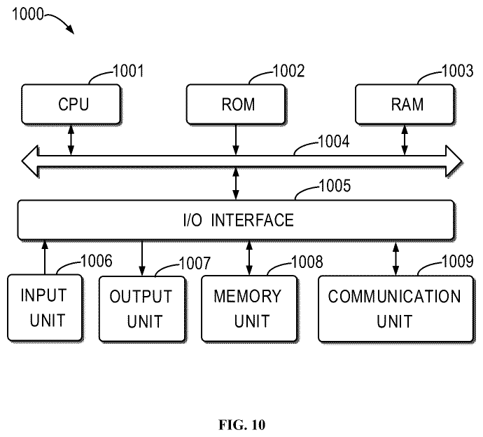

FIG. 10 illustrates a simplified block diagram of a device 1000 that is suitable for implementing some example embodiments of the present disclosure. As illustrated therein, the device 1000 includes a central processing unit (CPU) 1001 that may perform various appropriate actions and processing based on computer program instructions stored in a Read-Only Memory (ROM) 1002 or loaded from a memory unit 1008 to a Random-Access Memory (RAM) 1003. In the RAM 1003, there may further store various programs and data needed for operations of the device 1000. The CPU 1001, ROM 1002 and RAM 1003 are connected to each other via a bus 1004. An input/output (I/O) interface 1005 is also connected to the bus 1004.

Various components in the device 1000 are connected to the I/O interface 1005, including: an input unit 1006 such as a keyboard, a mouse and the like; an output unit 1007 such as various types of displays and loudspeakers, etc.; a memory unit 1008 such as a magnetic disk, an optical disk, and etc.; and a communication unit 1009 such as a network card, a modem, and a wireless communication transceiver, etc. The communication unit 1009 allows the device 1000 to exchange information/data with other devices via a computer network such as the Internet and/or various types of telecommunications networks. It is understood that the present disclosure may display, via the output unit 1007, real-time dynamic change information of the customer satisfaction, key factor identification information of a group of customers or individual customers subjected to the satisfaction, optimized strategy information, and strategy implementation effect assessment information, etc.

The processing unit 1001 may be implemented by one or more processing circuits. The processing unit 1001 may be configured to perform various processes and processing described above. For example, in some embodiments, the process described above may be implemented as a computer software program that is tangibly embodied on a machine readable medium, e.g., the memory unit 1008. In some embodiments, part or all of the computer program may be loaded and/or mounted onto the device 1000 via ROM 1002 and/or communication unit 1009. When the computer program is loaded to the RAM 1003 and executed by the CPU 1001, one or more steps of the process as described above may be executed.

It is to be understood that although FIG. 10 is shown as an illustrative device to perform the process or method shown above, the embodiments of the present disclosure may also be implemented at one or more quantum computers, the present disclosure does not limit this aspect.

The present disclosure may be implemented a system, a method and/or a computer program product. The computer program product may comprise a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present application may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various aspects of the present application.

Aspects of the present application are described herein with reference to flowchart illustrations and/or block diagrams of methods, apparatus (systems), and computer program products according to embodiments of the application. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods and computer program products according to various embodiments of the present application. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one aspect, there is provided a method, such as a computer-implemented method. The method comprises: presenting a first video with a tag indicating that the first video is marked by a first user, wherein the first video is generated by a second user based on a first media content being created by the first user; and displaying, based on an operation associated with the tag from a user, a profile page of the first user including one or more videos marked by the first user, wherein the one or more videos comprise the first video.

In some implementations, the method may be performed by a device operated by the first user. In some embodiments, the method further comprises: in response to a marking operation on the first video by the first user, generating the tag for the first video.

In some embodiments, the method further comprises: in response to an adding operation for adding a marked video from the first user, determining a plurality of candidate videos, wherein each of the plurality of candidate videos is generated based on a media content created by the first user; and displaying, to the first user, the plurality of candidate videos, wherein the marking operation on the first video comprises a selection on the first video among the plurality of candidate videos.

In some embodiments, the method further comprises: in response to a commenting operation on the first video from the first user, displaying a commenting area comprising prompt information indicating that the first video can be marked; wherein the marking operation on the first video comprises an operation for issuing a comment on the first video with the prompt information selected.

In some embodiments, the method further comprises: in response to a sharing operation on the first video from the first user, displaying a sharing area comprising a marking control indicating that the first video can be marked; wherein the marking operation on the first video comprises an operation for triggering the marking control.

In some embodiments, the marking operation is disabled if a total number of videos that have been marked by the first user reaches a predefined threshold.

In some embodiments, the method further comprises: removing the tag for the first video and removing the first video from the one or more videos based on a removing operation on the first video from the first user.

In some implementations, the method may be performed by a device operated by the second user. In some embodiments, the method further comprises: presenting, to the second user, a notification indicating that the first video is marked by the first user.

In some embodiments, the method further comprises: obtaining, from the second user, a selection operation on an identifier of the first user which is displayed on a messaging page including the notification; and displaying, based on the selection operation, the profile page of the first user.

In some embodiments, the method further comprises: removing the tag for the first video and removing the first video from the one or more videos based on determining that the first video is set as private by the second user.

In some implementations, a total number of the one or more videos marked by the first user is less than or equals to a predefined threshold.

In some implementations, the method may further comprise: removing the tag for the first video and removing the first video from the one or more videos after a time duration starting from a time when the first video is marked.

In another aspect, there is provided an electronic device. The electronic device comprises: at least one display; at least one memory; and at least one processor coupled with the at least one memory and configured to cause the device to: present, by the at least one display to a user, a first video with a tag indicating that the first video is marked by a first user, wherein the first video is generated by a second user based on a first media content being created by the first user; and display, based on an operation associated with the tag from the user, a profile page of the first user including one or more videos marked by the first user, wherein the one or more videos comprise the first video.

In a further aspect, there is provided a non-transient computer readable medium having instructions stored thereon, the instructions, when executed by a processor of a device, causing the device to: present a first video with a tag indicating that the first video is marked by a first user, wherein the first video is generated by a second user based on a first media content being created by the first user; and display, based on an operation associated with the tag from a user, a profile page of the first user including one or more videos marked by the first user, wherein the one or more videos comprise the first video.

In some embodiments, the device is further caused to: in response to a marking operation on the first video by the first user, generate the tag for the first video.

In some embodiments, the device is further caused to: in response to an adding operation for adding a marked video from the first user, determine a plurality of candidate videos, wherein each of the plurality of candidate videos is generated based on a media content created by the first user; and display, to the first user, the plurality of candidate videos, wherein the marking operation on the first video comprises a selection on the first video among the plurality of candidate videos.

In some embodiments, the device is further caused to: in response to a commenting operation on the first video from the first user, display a commenting area comprising prompt information indicating that the first video can be marked; wherein the marking operation on the first video comprises an operation for issuing a comment on the first video with the prompt information selected.

In some embodiments, the device is further caused to: in response to a sharing operation on the first video from the first user, display a sharing area comprising a marking control indicating that the first video can be marked; wherein the marking operation on the first video comprises an operation for triggering the marking control.

In some embodiments, the marking operation is disabled if a total number of videos that have been marked by the first user reaches a predefined threshold.

In some embodiments, the device is further caused to: remove the tag for the first video and remove the first video from the one or more videos based on a removing operation on the first video from the first user.

In some embodiments, the device is further caused to: present, to the second user, a notification indicating that the first video is marked by the first user.

In some embodiments, the device is further caused to: obtain, from the second user, a selection operation on an identifier of the first user which is displayed on a messaging page including the notification; and display, based on the selection operation, the profile page of the first user.

In some embodiments, the device is further caused to: remove the tag for the first video and remove the first video from the one or more videos based on determining that the first video is set as private by the second user.

In some embodiments, the device is further caused to: remove the tag for the first video and remove the first video from the one or more videos after a time duration starting from a time when the first video is marked.

In some embodiments, a total number of the one or more videos marked by the first user is less than or equals to a predefined threshold.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A method comprising:
presenting a first video with a tag indicating that the first video is marked by a first user, wherein the first video is generated by a second user based on a first media content being created by the first user; and
displaying, based on an operation associated with the tag from a user, a profile page of the first user including one or more videos marked by the first user, wherein the one or more videos comprise the first video.

2. The method of claim 1, further comprising:
in response to a marking operation on the first video by the first user, generating the tag for the first video.

3. The method of claim 2, further comprising:
in response to an adding operation for adding a marked video from the first user, determining a plurality of candidate videos, wherein each of the plurality of candidate videos is generated based on a media content created by the first user: and
displaying, to the first user, the plurality of candidate videos,
wherein the marking operation on the first video comprises a selection on the first video among the plurality of candidate videos.

4. The method of claim 2, further comprising:
in response to a commenting operation on the first video from the first user, displaying a commenting area comprising prompt information indicating that the first video can be marked;
wherein the marking operation on the first video comprises an operation for issuing a comment on the first video with the prompt information selected.

5. The method of claim 2, further comprising:
in response to a sharing operation on the first video from the first user, displaying a sharing area comprising a marking control indicating that the first video can be marked;
wherein the marking operation on the first video comprises an operation for triggering the marking control.

6. The method of claim 2, wherein the marking operation is disabled if a total number of videos that have been marked by the first user reaches a predefined threshold.

7. The method of claim 2, further comprising:
removing the tag for the first video and removing the first video from the one or more videos based on a removing operation on the first video from the first user.

8. The method of claim 1, further comprising:
presenting, to the second user, a notification indicating that the first video is marked by the first user.

9. The method of claim 8, further comprising:
obtaining, from the second user, a selection operation on an identifier of the first user which is displayed on a messaging page including the notification; and
displaying, based on the selection operation, the profile page of the first user.

10. The method of claim 8, further comprising:
removing the tag for the first video and removing the first video from the one or more videos based on determining that the first video is set as private by the second user.

11. The method of claim 1, wherein a total number of the one or more videos marked by the first user is less than or equals to a predefined threshold.

12. The method of claim 1, further comprising:
removing the tag for the first video and removing the first video from the one or more videos after a time duration starting from a time when the first video is marked.

13. An electronic device comprising:
at least one display;
at least one memory; and
at least one processor coupled with the at least one memory and configured to cause the device to:
present, by the at least one display, a first video with a tag indicating that the first video is marked by a first user, wherein the first video is generated by a second user based on a first media content being created by the first user; and
display, based on an operation associated with the tag from a user, a profile page of the first user including one or more videos marked by the first user, wherein the one or more videos comprise the first video.

14. The device of claim 13, wherein the device is further caused to:
in response to a marking operation on the first video by the first user, generate the tag for the first video.

15. The device of claim 14, wherein the device is further caused to:
in response to an adding operation for adding a marked video from the first user, determine a plurality of candidate videos, wherein each of the plurality of candidate videos is generated based on a media content created by the first user; and
display, to the first user, the plurality of candidate videos,
wherein the marking operation on the first video comprises a selection on the first video among the plurality of candidate videos.

16. The device of claim 14, wherein the device is further caused to:
in response to a commenting operation on the first video from the first user, display a commenting area comprising prompt information indicating that the first video can be marked;
wherein the marking operation on the first video comprises an operation for issuing a comment on the first video with the prompt information selected.

17. The device of claim 14, wherein the device is further caused to:
in response to a sharing operation on the first video from the first user, display a sharing area comprising a marking control indicating that the first video can be marked;
wherein the marking operation on the first video comprises an operation for triggering the marking control.

18. The device of claim 13, wherein the device is further caused to:
present, to the second user, a notification indicating that the first video is marked by the first user.

19. The device of claim 18, wherein the device is further caused to:
obtain, from the second user, a selection operation on an identifier of the first user which is displayed on a messaging page including the notification; and
display, based on the selection operation, the profile page of the first user.

20. A non-transient computer readable medium having instructions stored thereon, the instructions, when executed by a processor of a device, causing the device to:
present a first video with a tag indicating that the first video is marked by a first user, wherein the first video is generated by a second user based on a first media content being created by the first user; and
display, based on an operation associated with the tag from a user, a profile page of the first user including one or more videos marked by the first user, wherein the one or more videos comprise the first video.
